(19) United States
(12) Patent Application Publication
(10) Pub. No.: US 2005/0187867 A1
(43) Pub. Date: Aug. 25, 2005

(54) System and method for associating identifiers with transactions

(76) Inventors: Jeremy N. Sokolic, New York, NY (US); Balraj Suneja, Norwalk, CT (US); Gautam Sinha, San Ramon, CA (US); Amitava Parial, Newark, CA (US); Sarabjeet Singh, San Jose, CA (US); Sanjeev Dheer, Scarsdale, NY (US)

Correspondence Address: LEE & HAYES, PLLC, 421 W. RIVERSIDE AVE, STE 500, SPOKANE, WA, 99201, US

(21) Appl. No.: 11/047,359

(22) Filed: Jan. 31, 2005

Related U.S. Application Data
(63) Continuation-in-part of application No. 10/040,314, filed on Jan. 3, 2002.
(60) Provisional application No. 60/540,667, filed on Jan. 30, 2004.

(51) Int. Cl. G06F 17/60

(52) U.S. Cl. 705/39; 705/35

(57) ABSTRACT

Financial transaction data is retrieved from a financial institution. The financial transaction data includes a transaction value. The transaction value is compared to multiple pre-defined transaction identifiers and associated with one of the transaction identifiers. The financial transaction data and the associated transaction identifier are then stored in a storage mechanism.

### RELATED APPLICATIONS

This application is a continuation-in-part of co-pending application Ser. No. 10/040,314, filed Jan. 3, 2002, entitled “Method and Apparatus for Retrieving and Processing Data”, and incorporated herein by reference.

Further, this application claims the benefit of U.S. Provisional Application No. 60/540,667, filed Jan. 30, 2004, the disclosure of which is also incorporated herein by reference.

### TECHNICAL FIELD

The present invention relates to associating transaction identifiers with one or more transactions.

### BACKGROUND

Individuals, businesses, and other organizations typically maintain one or more financial accounts at one or more financial institutions. Financial institutions include, for example, investment institutions, life insurance vendors, banks, savings and loans, credit unions, mortgage companies, lending companies, and stock brokers. Financial accounts may include asset accounts (such as brokerage accounts, investment accounts, 401k accounts, other retirement accounts, mutual fund accounts, life insurance and annuity accounts, bank savings accounts, checking accounts, and certificates of deposit (CDs)) and liability accounts (such as credit card accounts, mortgage accounts, home equity loans, overdraft protection, and other types of loans). Liability accounts may also be referred to as “debt accounts”.

Many financial institutions allow customers to access information regarding their accounts via the Internet or other remote connection mechanism (often referred to as “online banking”). Typically, the customer navigates, using a web browser application, to a web site maintained by the financial institution. The web site allows the customer to login by entering a user identification and an associated password. If the financial institution accepts the user identification and password, the customer is permitted to access information (e.g., account holdings and account balances) regarding the financial accounts maintained at that financial institution.

Similarly, other organizations and institutions allow customer access to other types of accounts, such as email accounts, award (or reward) accounts, online bill payment accounts, etc. A user may navigate a web site or other information source to receive status information regarding one or more of their accounts.

Different financial institutions may use different transaction codes or identifiers for similar transactions. Different types of transactions include buy, sell, transfer, deposit, withdraw, redeem, and the like. For example, a funds transfer transaction at one financial institution may have a particular identifier associated with the transaction (e.g., FXFR0034552), whereas a similar transaction at another financial institution may have a different associated transaction identifier (e.g., XFUNDS-A4D44F). Attempts to aggregate transaction information from different financial institutions is difficult when different identifiers are used for similar transactions, holdings, and other account information.

The systems and methods described herein addresses these and other difficulties by categorizing transaction data from multiple sources using a common set of transaction identifiers.

### BRIEF DESCRIPTION OF THE DRAWINGS

FIG. 1 illustrates an example network environment in which various servers, computing devices, and a financial analysis system exchange data across a network, such as the Internet.

FIG. 2 is a block diagram showing example components and modules of a system to associate transaction identifiers with one or more transactions.

FIG. 3 is a flow diagram illustrating a procedure for categorizing received transaction data.

FIG. 4 is a block diagram showing pertinent components of a computer in accordance with the invention.

### DETAILED DESCRIPTION

The system and methods described herein are capable of retrieving data from one or more data sources, such as financial institutions. A particular data source may contain financial transaction information associated with one or more accounts of one or more account holders. Each data element retrieved is associated with a particular identifier, such as an asset identifier or a transaction identifier. Similar identifiers are used for data retrieved from multiple financial institutions and multiple financial accounts, thereby allowing the retrieved data to be normalized across the multiple institutions and accounts.

As used herein, the terms “account holder”, “customer”, “user”, and “client” are interchangeable. “Account holder” refers to any person or entity having access to an account. A particular account may have multiple account holders (e.g., a joint checking account having husband and wife as account holders or a corporate account identifying several corporate employees as account holders).

Various financial transaction and financial institution examples are provided herein for purposes of explanation. However, it will be appreciated that the systems and procedures described herein can be used with any type of data from any data source. Example financial accounts include savings accounts, money market accounts, checking accounts (both interest-bearing and non-interest-bearing), brokerage accounts, credit card accounts, mortgage accounts, home equity loan accounts, overdraft protection accounts, margin accounts, personal loan accounts, and the like. Example financial transactions include buy, sell, transfer, deposit, withdraw, redeem, and the like. Example financial institutions include banks, savings and loans, credit unions, mortgage companies, mutual fund companies, lending companies, and stock brokers.

Additionally, a data aggregation system may aggregate data from multiple sources, such as multiple financial accounts, multiple email accounts, multiple online award (or reward) accounts, multiple news headlines, and the like. Similarly, the data retrieval and data processing systems and methods discussed herein may be applied to collect data from any type of account containing any type of data. Thus, the methods and systems described herein can be applied to a data aggregation system or any other account management system, and are not limited to the financial analysis systems and procedures discussed in the examples provided herein.

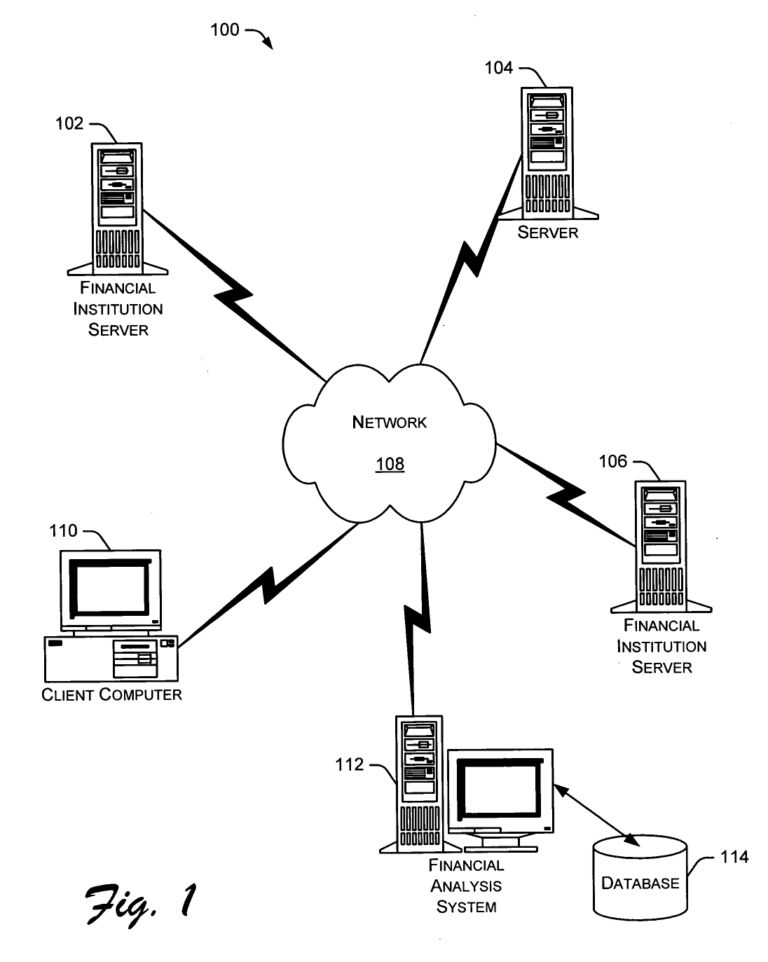

FIG. 1 illustrates an example network environment 100 in which various servers, computing devices, and a financial analysis system exchange data across a data communication network. The network environment of FIG. 1 includes multiple financial institution servers 102 and 106 coupled to a data communication network 108, such as the Internet. Data communication network 108 may be any type of data communication network using any network topology and any communication protocol. Further, network 108 may include one or more sub-networks (not shown) which are interconnected with one another.

Another server 104, a client computer 110 and a financial analysis system 112 are also coupled to network 108. Financial analysis system 112 is coupled to a database 114. Database 114 stores various information used by financial analysis system 112, as discussed herein. Financial analysis system 112 performs various transaction analysis functions, account analysis functions, data analysis functions, and aggregation functions, which are discussed in greater detail below. Although not shown in FIG. 1, financial institution servers 102 and 106 may include a database that stores information associated with the particular financial institution.

Servers 102-106, client computer 110, and financial analysis system 112 may be any type of computing device, such as a desktop computer, a laptop computer, a handheld computer, a personal digital assistant (PDA), a cellular phone, a set top box, or a game console. Client computer 110 is capable of communicating with one or more servers 102-106, for example, to access information about a financial institution, access account information, and execute various transactions.

The communication links shown between network 108 and the various devices (102, 104, 106, 110, and 112) shown in FIG. 1 can use any type of communication medium and any communication protocol. For example, any of the communication links shown in FIG. 1 may be a wireless link (e.g., a radio frequency (RF) link or a microwave link) or a wired link accessed via a public telephone system, local area network (LAN), wide area network (WAN), or another communication network.

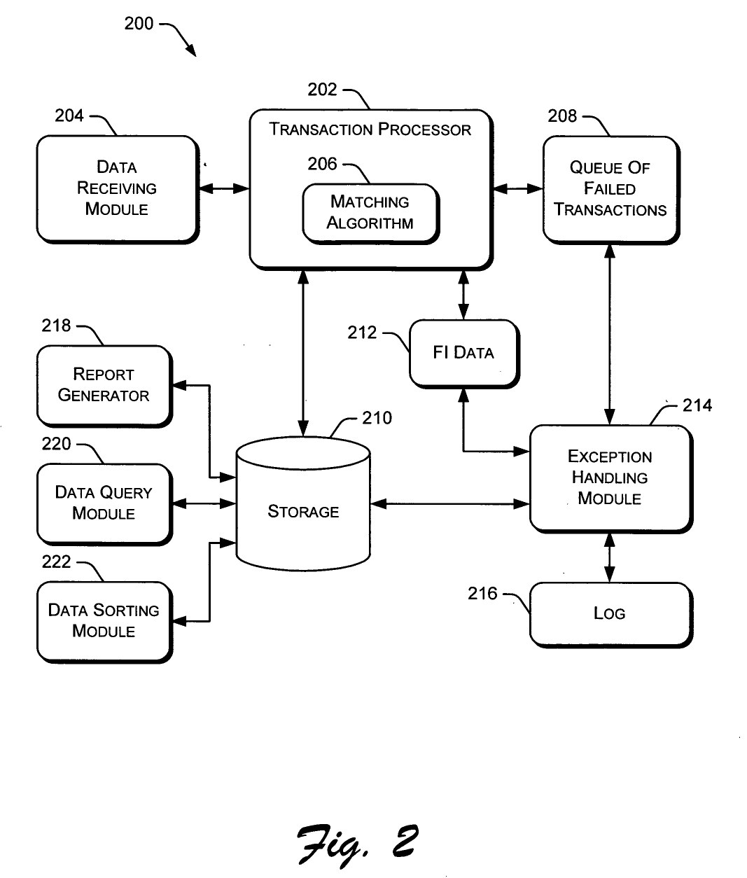

FIG. 2 is a block diagram showing example components and modules of a system 200 to associate transaction identifiers with one or more transactions. One or more of the components and modules shown in FIG. 2 may be part of financial analysis system 112 (FIG. 1). In a particular embodiment, the components and modules shown in FIG. 2 are separate from financial analysis system 112.

System 200 classifies transactions into a defined category and associates the transaction with a particular transaction identifier (also referred to as a “transaction code”). The transactions are received from any number of sources (e.g., financial institutions) and, after being categorized, can be queried, sorted, and otherwise processed based on the associated transaction identifier. Categorizing transactions from multiple financial institutions normalizes the transaction data to allow processing of the transaction data across the multiple financial institutions, even though different financial institutions may use different transaction data values or terminology. In one embodiment, the normalized transaction data is accessible by other systems, such as portfolio accounting systems and financial analysis systems, that track and report investment performance and other statistics.

A transaction processor 202 is coupled to receive data, such as transaction data, from a data receiving module 204. Data receiving module 204 can receive data from any number of data sources using various data receiving and data retrieving techniques. For example, data receiving module 204 can “harvest” data from one or more web sites associated with any number of financial institutions. Data harvesting (also referred to as “screen scraping”) is a process that allows, for example, an automated script to retrieve data from one or more web pages associated with a web site. For example, a particular data harvesting script may retrieve transaction data from a particular financial institution by navigating to specific web pages associated with the particular financial institution. The data harvesting script knows where the transaction data is located on each of the web pages and retrieves the data from those locations. Since each financial institution may have a different web site architecture and web page layout, a separate data harvesting script may be required for each financial institution. Additionally, these scripts may require regular modification as one or more financial institutions change their web site architecture or web page layout.

Alternatively, data receiving module 204 may receive data from a data source using, for example, OFX (Open Financial Exchange) standard, QIF (Quicken Interchange Format) format, or any other data format. Alternatively, data receiving module 204 may receive one or more data files (e.g., text files) from financial institutions containing transaction data. OFX is a specification for the electronic exchange of financial data between financial institutions, businesses and consumers via the Internet. OFX supports a wide range of financial activities including consumer and business banking, consumer and business bill payment, bill presentment, and investment tracking, including stocks, bonds, mutual funds, and 401(k) account details. QIF is a specially formatted text file that allows a user to transfer Quicken transactions from one Quicken account register into another Quicken account register or to transfer Quicken transactions to or from another application that supports the QIF format. Data is retrieved from the source and a procedure identifies data of interest. The data of interest may be, for example, data associated with a particular financial institution or a particular type of transaction. The identified data is then processed by transaction processor 202.

Transaction processor 202 categorizes the data received from data receiving module 204 using a matching algorithm 206. As discussed in greater detail below, matching algorithm 206 uses financial institution data 212 and other information to categorize transactions and associate an identifier with each transaction. The received transaction data includes, for example, a financial institution ID and a transaction value. The transaction value is the name of the transaction used by the particular financial institution. For example, one financial institution may use “SELL” to identify a sell transaction while another financial institution may use “SL”, “S”, or some other value to identify a sell transaction.

Transaction processor 202 is also coupled to a queue of failed transactions 208. This queue 208 contains transaction data for transactions that could not be categorized by transaction processor 202. Queue 208 is coupled to an exception handling module 214. Exception handling module 214 may also be referred to as an “exception handling tool”. Exception handling module 214 processes transaction data that was not categorized by transaction processor 202. For example, an administrator (or other user) may review the transaction data and identify an appropriate category for the transaction. Additionally, the administrator may update the financial institution data 212 such that matching algorithm 206 properly identifies similar transaction data received in the future. Exception handling module 214 also allows an administrator to add new categorizing rules, delete existing rules, or modify existing rules. By continually adding, deleting and modifying rules, the overall performance of transaction processor 202 in categorizing transactions improves over time.

A log 216 is coupled to exception handling module 214 and contains a listing of transaction data processed by exception handling module 214. Exception handling module 214 processes transactions that were not recognized (or categorized) by transaction processor 202. For example, a transaction may have an unrecognized transaction label, such as “Online Sale”. These unrecognized transaction labels may be new labels that transaction processor 202 had not previously encountered, or the transaction labels may be a modification of an existing label. In these situations, the financial institution data 212 is updated to account for the new or modified transaction label such that future transactions using that transaction label will be handled properly by transaction processor 202.

A storage device 210 is coupled to transaction processor 202, exception handling module 214, a report generator 218, a data query module 220, and a data sorting module 222. Storage device 210 stores various data generated by and used by transaction processor 202 and exception handling module 214. Additionally, other components and modules (such as report generator 218, data query module 220, and data sorting module 222) interact with storage device 210 when performing various procedures or functions.

In particular embodiments, one or more of the components shown in FIG. 2 may be omitted. Alternatively, or one or more additional components may be added to the system shown in FIG. 2. Any two or more of the components shown in FIG. 2 may be combined with one another or combined with another component. For example, queue 208 and exception handling module 214 may be combined in a single component. The components shown in FIG. 2 can be implemented in hardware, software, or combinations of hardware and software.

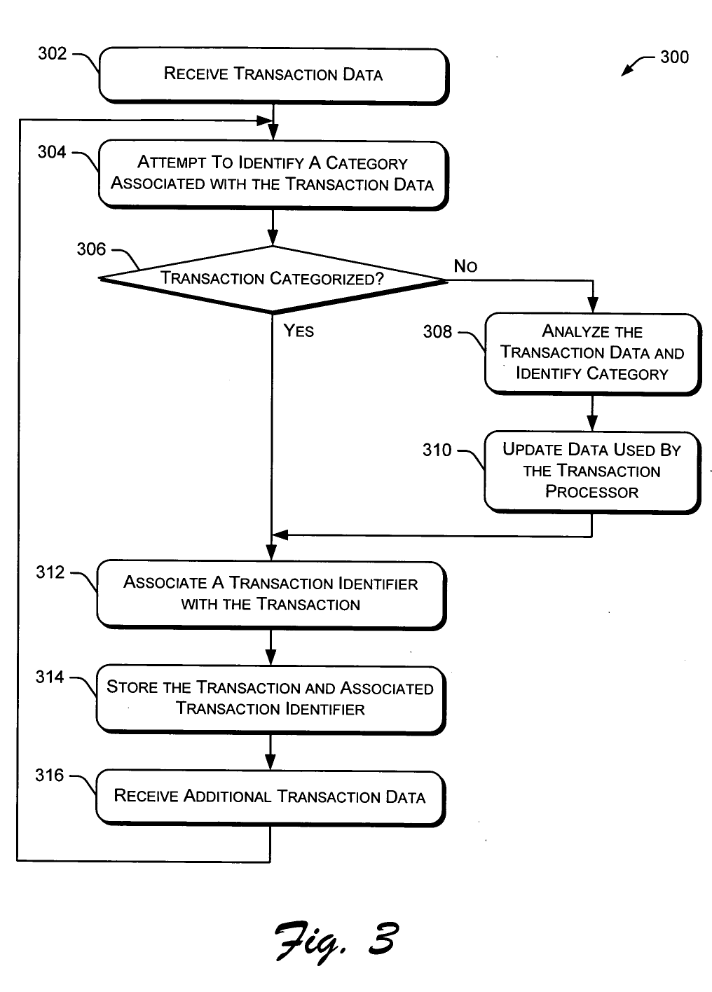

FIG. 3 is a flow diagram illustrating a procedure 300 for categorizing received transaction data. Initially, the transaction data is received from the data receiving module (block 302). The procedure then attempts to identify a category associated with the transaction data (block 304). In one embodiment, the transaction processor compares the received transaction data with a known (e.g., pre-defined) set of financial institution-specific seed data. This seed data correlates transaction terminology used by different financial institutions with a particular transaction category (i.e., the transaction identifier). When the first match is found in the seed data, the corresponding transaction identifier is associated with the transaction. Table 1 below illustrates example seed data and a corresponding transaction identifier. For example, financial institution 10001 uses the terms “sell” and “SELL” for different sell transactions. Similarly, financial institution 1002 uses the terms “SELL*”, and “Sell 100 Shares ACME” for different sell transactions. The transaction processor associates any of these four terms with transaction identifier “1”, which indicates a sell. Thus, the different terms used by different financial institutions for the same type of transaction are normalized to a common transaction identifier.

TABLE 1

| | | Transaction |
|---|---|---|
| FI ID | Transaction Value (source data) | Identifier |
| 10001 | SELL | 1 (sell) |
| 10001 | Sell | 1 (sell) |
| 10001 | BOUGHT | 2 (buy) |
| 10001 | Bought | 2 (buy) |
| 10002 | SELL 4 SHARES OF MSFT @ 56.34 | 1 (sell) |
| 10002 | SELL* | 1 (sell) |
| 10002 | Brokerage Purchase | 2 (buy) |
| 10002 | Brokerage Redemption | 1 (sell) |
| 10003 | Buy | 2 (buy) |

The seed data shown in Table 1 is intended to grow and change over time based on the data collected from different financial institutions. Initially, the seed data is populated using a data obtained from known systems. Each unique transaction value that is found in the “transaction description” field of the data source will be stored in the seed data and assigned the appropriate transaction identifier. The matching algorithm in the transaction processor will first check financial institution-specific seed data to determine if there is a match. If not, the matching algorithm attempts to match generic seed data.

Generic seed data is generated by analyzing common patterns across multiple financial institutions such that the generic data can be useful with a new financial institution without any specific seed data. The use of generic seed data also reduces the overall amount of seed data by identifying common transaction values used by multiple financial institutions. For example, “Sale=Sell” and “Sold=Sell” are common transaction value matches that work with many different financial institutions. For any financial institutions that do not comply with these generic rules, specific seed data is generated and associated with those financial institutions. This specific seed data takes precedence over the generic seed data for those particular financial institutions. Both the generic seed data and the specific seed data is ordered (or ranked) in a particular manner to ensure that a correct match is identified.

Referring again to FIG. 3, if, at block 306, the transaction data was not properly categorized (e.g., the transaction processor could not categorize the transaction), the procedure branches to block 308 where an administrator (or other user) analyzes the transaction data and identifies a category associated with the transaction. The procedure then updates the data used by the transaction processor to allow the transaction processor to properly categorized similar transactions in the future (block 310). For example, a new entry may be included in Table 1 above to identify the analyzed transaction value with a particular transaction identifier. The functions performed in blocks 308 and 310 may be performed soon after an attempt to categorize a transaction fails. Alternatively, the functions performed in blocks 308 and 310 may be performed at a future day and time. In this alternate situation, procedure 300 continues receiving and processing data associated with other transactions while waiting for the failed transaction to be analyzed and categorized. In one embodiment, block 310 of FIG. 3 also stores information regarding the analyzed transaction in a log (e.g., log 216) for future reference.

After a transaction has been categorized, procedure 300 continues by associating a transaction identifier with the transaction (block 312). The transaction identifier indicates a particular category with which the transaction is associated. The procedure then stores the transaction and associated transaction identifier (block 314). In one embodiment, the transaction is stored in a transaction table that contains one or more other categorized transactions. Finally, procedure 300 receives additional transaction data (block 316) and returns to block 304 to identify a category associated with the transaction data.

The matching algorithm used to categorize transactions processes seed data in a particular order. The matching algorithm first applies specific seed data (e.g., data specific to a financial institution) prior to applying generic seed data. Thus, if the specific seed data contains an exception to the generic seed data, the specific seed data will be applied first and any appropriate matches will be identified. Additionally, the specific seed data and generic seed data is ordered such that more specific matches occur before less specific matches. For example, “Sell to cover” will be ordered ahead of “Sell” to avoid having a “Sell to cover” transaction be categorized as a general “Sell” transaction. The matching algorithm also attempts to find an exact match before a partial match is accepted. For example, the algorithm would attempt to make an exact match for “Interest-income” or “Interest-bond” prior to matching either value with “Interest”, which is a partial match.

As mentioned above, each transaction that cannot be assigned a transaction identifier is flagged for further processing by the exception handling module 214. The exception handling module performs two functions: 1. queuing the flagged transactions and presenting them to an administrator or other user, and 2. updating the seed data used by the transaction processor to categorize transactions. When a flagged transaction is queued for further processing, a link is provided to the source of the transaction data, such as the html link, OFX location, QIF file, or financial institution data file. Updating the seed data allows an administrator to include the new transaction value in the seed data and to assign the appropriate transaction identifier to the new transaction value.

In one embodiment, operation of the exception handling module bay be activated or deactivated. If the exception handling module is activated, it operates in the manner discussed above. If the exception handling module is deactivated, transactions that cannot be categorized using the existing seed data are ignored.

The normalizing of transaction data (i.e., assigning common transaction identifiers) is useful when transaction data is received from multiple sources (e.g., multiple financial institutions). Each financial institution may use different identifiers or other terms for the same type of transaction. For example, one financial institution may use the identifier “SELL” while another financial institution uses the identifier “SL” for the same transaction. By normalizing the transaction data, transactions from multiple financial institutions can be grouped in a logical manner. Thus, various financial analysis tools and procedures can analyze transactions across multiple financial institutions or other data sources. For example, report generator 218 can generate transaction reports that accurately contain transaction information from multiple different sources.

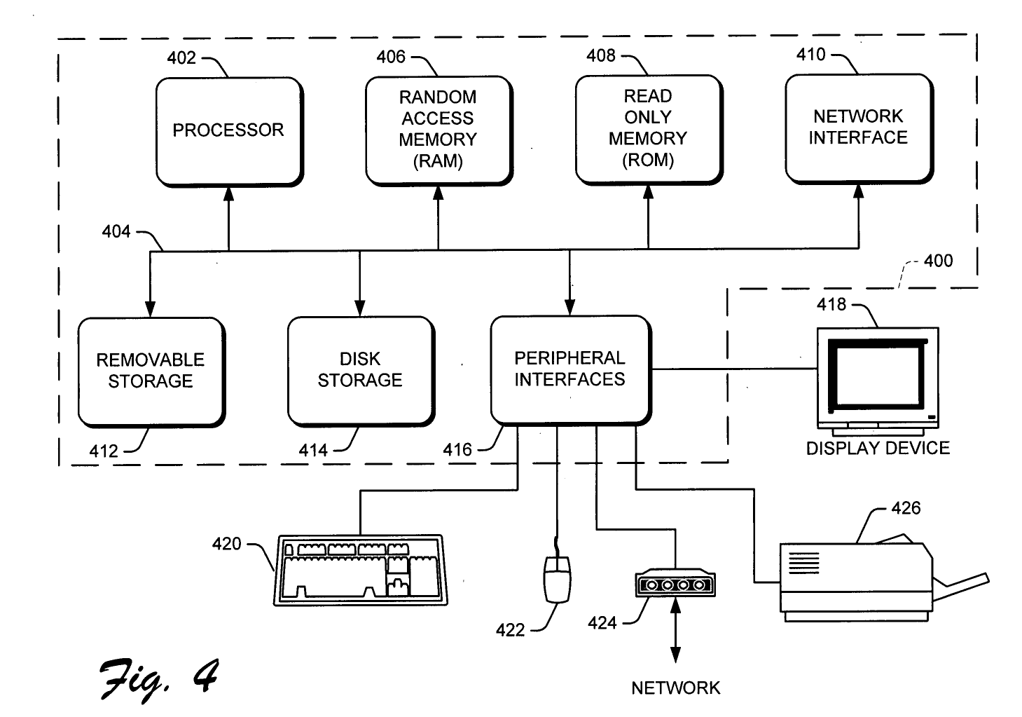

FIG. 4 is a block diagram showing pertinent components of a computer 400 in accordance with the invention. A computer such as that shown in FIG. 4 can be used, for example, to perform various procedures such as those discussed herein. Computer 400 can also be used to access a data source or other device to access various financial information. The computer shown in FIG. 4 can function as a server, a client computer, or a financial analysis system, of the types discussed herein.

Computer 400 includes at least one processor 402 coupled to a bus 404 that couples together various system components. Bus 404 represents one or more of any of several types of bus structures, such as a memory bus or memory controller, a peripheral bus, and a processor or local bus using any of a variety of bus architectures. A random access memory (RAM) 406 and a read only memory (ROM) 408 are coupled to bus 404. Additionally, a network interface 410 and a removable storage device 412, such as a floppy disk or a CD-ROM, are coupled to bus 404. Network interface 410 provides an interface to a data communication network such as a local area network (LAN) or a wide area network (WAN) for exchanging data with other computers and devices. A disk storage 414, such as a hard disk, is coupled to bus 404 and provides for the non-volatile storage of data (e.g., computer-readable instructions, data structures, program modules and other data used by computer 400). Although computer 400 illustrates a removable storage 412 and a disk storage 414, it will be appreciated that other types of computer-readable media which can store data that is accessible by a computer, such as magnetic cassettes, flash memory cards, digital video disks, and the like, may also be used in the example computer.

Various peripheral interfaces 416 are coupled to bus 404 and provide an interface between the computer 400 and the individual peripheral devices. Example peripheral devices include a display device 418, a keyboard 420, a mouse 422, a modem 424, and a printer 426. Modem 424 can be used to access other computer systems and devices directly or by connecting to a data communication network such as the Internet.

A variety of program modules can be stored on the disk storage 414, removable storage 412, RAM 406, or ROM 408, including an operating system, one or more application programs, and other program modules and program data. A user can enter commands and other information into computer 400 using the keyboard 420, mouse 422, or other input devices (not shown). Other input devices may include a microphone, joystick, game pad, scanner, satellite dish, or the like.

Computer 400 may operate in a network environment using logical connections to other remote computers. The remote computers may be personal computers, servers, routers, or peer devices. In a networked environment, some or all of the program modules executed by computer 400 may be retrieved from another computing device coupled to the network.

Typically, the computer 400 is programmed using instructions stored at different times in the various computer-readable media of the computer. Programs and operating systems are often distributed, for example, on floppy disks or CD-ROMs. The programs are installed from the distribution media into a storage device within the computer 400. When a program is executed, the program is at least partially loaded into the computer's primary electronic memory. As described herein, the invention includes these and other types of computer readable media when the media contains instructions or programs for implementing the steps described below in conjunction with a processor. The invention also includes the computer itself when programmed according to the procedures and techniques described herein.

For purposes of illustration, programs and other executable program components are illustrated herein as discrete blocks, although it is understood that such programs and components reside at various times in different storage components of the computer, and are executed by the computer's processor. Alternatively, the systems and procedures described herein can be implemented in hardware or a combination of hardware, software, and/or firmware. For example, one or more application specific integrated circuits (ASICs) can be programmed to carry out the systems and procedures described herein.

Although the description above uses language that is specific to structural features and/or methodological acts, it is to be understood that the invention defined in the appended claims is not limited to the specific features or acts described. Rather, the specific features and acts are disclosed as example forms of implementing the invention.

1. A method comprising:
retrieving financial transaction data from a financial institution, wherein the financial transaction data includes a transaction value;
comparing the transaction value to a plurality of pre-defined transaction identifiers;
associating the transaction with one of the transaction identifiers; and
storing the financial transaction data and the associated transaction identifier.

2. A method as recited in claim 1 wherein retrieving financial transaction data from a financial institution includes retrieving data from a web site associated with a financial institution.

3. A method as recited in claim 1 wherein the transaction identifiers are applied to a plurality of transaction values to normalize the plurality of transaction values.

4. A method as recited in claim 1 wherein comparing the transaction value to a plurality of pre-defined transaction identifiers includes comparing the transaction value to the plurality of pre-defined transaction identifiers in a pre-defined order.

5. A method as recited in claim 4 further comprising manually associating transaction identifiers with each flagged financial transactions.

6. A method as recited in claim 1 further comprising retrieving additional information regarding the financial transaction data from the financial institution.

7. A method as recited in claim 1 wherein comparing the transaction value to a plurality of transaction identifiers includes:
comparing specific seed data to the transaction value; and
if a match is not indicated with the specific seed data, comparing general seed data to the transaction value.

8. One or more computer-readable memories containing a computer program that is executable by a processor to perform the method recited in claim 1.

9. A method comprising:
accessing a web page associated with a financial institution;
retrieving data from the web page using a data harvesting script;
identifying financial transaction data contained in the data retrieved from the web page, wherein the financial transaction data includes a transaction value; and
associating the financial transaction data with one of a plurality of pre-defined transaction identifiers.

10. A method as recited in claim 9 further comprising storing the financial transaction data and the associated transaction identifier.

11. A method as recited in claim 9 wherein retrieving data from the web page using a data harvesting script utilizes a screen scraping process.

12. A method as recited in claim 9 wherein associating the financial transaction data with one of a plurality of pre-defined transaction identifiers includes:
attempting to automatically associate the financial transaction data with a transaction identifier based on seed data;
if the financial transaction data is not automatically associated with a transaction identifier, manually associating the financial transaction with a proper transaction identifier.

13. A method as recited in claim 12 further comprising updating the seed data to subsequently associate the financial transaction data with the proper transaction identifier.

14. One or more computer-readable memories containing a computer program that is executable by a processor to perform the method recited in claim 9.

15. One or more computer readable media having stored thereon a plurality of instructions that, when executed by a processor, causes the processor to:
harvesting first financial transaction data associated with a first financial institution, wherein the first financial transaction data is harvested from a web page associated with the first financial institution;
retrieving second financial transaction data associated with a second financial institution, wherein the second financial transaction data is retrieved from a data file associated with the second financial institution;
associating the first financial transaction data with one of a plurality of pre-defined transaction identifiers; and
associating the second financial transaction data with one of the plurality of pre-defined transaction identifiers.

16. One or more computer readable media as recited in claim 15, wherein associating the first financial transaction data with one of a plurality of pre-defined transaction identifiers includes:
comparing specific seed data to the first financial transaction data; and
if a match is not indicated with the specific seed data, comparing general seed data to the first financial transaction data.

17. One or more computer readable media as recited in claim 16, further comprising flagging the first financial transaction data if a match is not indicated with the general seed data.

18. One or more computer readable media as recited in claim 16, further comprising if a match is not indicated with the general seed data, manually associating one of the plurality of transaction identifiers with the first financial transaction data.

19. One or more computer readable media as recited in claim 18, further comprising updating the specific seed data if a match is not indicated with the general seed data and a match is not indicated with the specific seed data.

20. One or more computer readable media as recited in claim 15, further comprising:
storing the first financial transaction data and the associated transaction identifier in a storage device; and
storing the second financial transaction data and the associated transaction identifier in the storage device.
